(19) United States
(12) Patent Application Publication
(10) Pub. No.: US 2020/0202315 A1
(43) Pub. Date: Jun. 25, 2020

(54) System and Method for Identifying and Targeting Financial Devices to Promote Recurring Transactions

(71) Applicant: Visa International Service Association, San Francisco, CA (US)

(72) Inventors: Shankardas Mohandas, Foster City, CA (US); Charles Ding, San Carlos, CA (US)

(21) Appl. No.: 16/612,547

(22) PCT Filed: May 12, 2017
(86) PCT No.: PCT/US2017/032356

§ 371 Date: Nov. 11, 2019

(51) Int. Cl. G06Q 20/10; G06Q 20/40; G06Q 40/02; G06Q 20/14

(52) U.S. Cl. CPC G06Q 20/102; G06Q 20/405; G06Q 20/14; G06Q 20/108; G06Q 40/02

(57) ABSTRACT

Described are systems and methods for identifying and communicatively targeting financial devices to promote recurring transactions. The method includes receiving, with at least one processor, financial device data for a plurality of transactions over a sample time period, the financial device data including transaction time, transaction count, transaction amount, merchant category, transaction type, or any combination thereof. The method also includes identifying, with at least one processor, at least one target financial device from the financial device data based at least partially on at least one of the parameters having a value in a specified range for the at least one parameter. The method further includes receiving, with at least one processor, identification data of at least one target financial device holder, and automatically generating and transmitting at least one communication to the at least one target financial device holder.

### BACKGROUND OF THE INVENTION

### 1. Field of the Invention

Disclosed embodiments relate generally to a system and method for identifying and targeting recurring transaction behavior and, in one particular embodiment, to a system and method employing a predictive model to identify recurring transaction propensity in financial device data, and generating targeted communications to holders thereof.

### 2. Technical Considerations

Encouraging repeated and recurring use of a financial device (e.g., a credit card) is a top objective for financial device issuers (e.g., credit card issuers, such as banks and credit unions, also called “issuer institutions”). Issuer institutions benefit by charging annual fees or interest to the financial device holder (e.g., cardholder), as well as by charging transaction fees to merchants each time the financial device is used to complete a transaction. Therefore, issuer institutions prioritize not just opening new financial device accounts, but promoting continued and repeated use of such financial devices. However, promoting increased financial device usage has been largely a matter of “black box” marketing campaigns, where promotions and advertisements are widely distributed with little-to-no ability to determine if the campaigns have successfully or directly influenced recurring transaction behavior. Although surveys, focus groups, and case studies can be conducted to receive feedback from financial device holders, these methods may be less empirical, time consuming, and costly to receive reliable results. Moreover, these methods may be unable to adapt and respond to ongoing transaction behavior, and iterative improvement to marketing campaigns can be slow.

Therefore, there is a need in the art to automatically identify financial devices that are more likely to engage in recurring transaction behavior. Moreover, there is a need in the art to automatically identify financial device holders associated with those financial devices and target the financial device holders with data-driven communications. Furthermore, there is a need in the art to automatically receive monitored feedback from financial device holders engaging in the desired recurrent behavior, and to iteratively improve the processes for identifying financial devices with recurrent transaction propensity and communicating to the associated financial device holders.

### SUMMARY OF THE INVENTION

Accordingly, and generally, provided is a system and computer-implemented method for identifying and communicatively targeting financial devices to promote recurring transactions. Preferably, provided is a system and computer-implemented method for identifying and communicatively targeting financial devices by receiving financial device data and identifying target financial devices based at least partially on parameter values of the financial device data. Preferably, further provided is a system and computer-implemented method that receives identification data of a financial device holder associated with the target financial device and automatically generates and transmits a communication to the financial device holder.

According to one preferred and non-limiting embodiment or aspect, provided is a computer-implemented method for identifying and communicatively targeting financial devices to promote recurring transactions. The method includes (a) receiving, with at least one processor, financial device data for a plurality of transactions associated with a plurality of financial devices over a sample time period. The financial device data includes at least one of the following parameters for each financial device of the plurality of financial devices: transaction time, transaction count, transaction amount, merchant category, transaction type, or any combination thereof. The method also includes (b) identifying, with at least one processor, at least one target financial device from the financial device data based at least partially on at least one of the parameters having a value in a specified range for the at least one parameter, the value at least partially correlated with a propensity of the at least one target financial device to engage in recurring transactions. The method further includes (c) receiving, with at least one processor, identification data of at least one target financial device holder associated with the at least one identified target financial device. The method further includes (d) automatically generating and transmitting at least one communication to the at least one target financial device holder.

In further preferred and non-limiting embodiments or aspects, the computer-implemented method may include (e) determining, with at least one processor, at least one reactive financial device holder from the at least one target financial device holder that engaged in at least one new recurring transaction during a second sample time period. The method may also include (f) based at least partially on the determination of the at least one reactive financial device holder, modifying a method of communication with the at least one target financial device holder. The method may further include repeating steps (b) through (f) at predefined intervals.

In further preferred and non-limiting embodiments or aspects, the financial device data may include at least the transaction time parameter, and the identification in step (b) may include, for each financial device: determining, with at least one processor, a transaction time of a most recent transaction completed by the financial device; determining, with at least one processor, a current time; comparing, with at least one processor, the transaction time of the most recent transaction to the current time; and based at least partially on the comparison, designating the financial device as a target financial device of the at least one target financial device.

In further preferred and non-limiting embodiments or aspects, the financial device data may include at least the transaction type parameter, and the identification in step (b) may include, for each financial device: determining, with at least one processor, a number of transactions completed online in a period of time less than or equal to the sample time period; comparing, with at least one processor, the number of transactions completed online to a predetermined threshold count; and based at least partially on the comparison, designating the financial device as a target financial device of the at least one target financial device.

In further preferred and non-limiting embodiments or aspects, the financial device data may include at least the transaction type parameter, and the identification in step (b) may include, for each financial device: determining, with at least one processor, a number of face-to-face transactions completed in a period of time less than or equal to the sample time period; comparing, with at least one processor, the number of face-to-face transactions completed to a predetermined threshold count; and based at least partially on the comparison, designating the financial device as a target financial device of the at least one target financial device.

In further preferred and non-limiting embodiments or aspects, the financial device data may include at least the transaction amount parameter, and the identification in step (b) may include, for each financial device: determining, with at least one processor, a total transaction amount for all transactions completed in a period of time less than or equal to the sample time period; comparing, with at least one processor, the total transaction amount to a predetermined threshold amount; and based at least partially on the comparison, designating the financial device as a target financial device of the at least one target financial device.

In further preferred and non-limiting embodiments or aspects, the financial device data may include at least the merchant category parameter, and the identification in step (b) may include, for each financial device: determining, with at least one processor, a total number of transactions completed in a period of time less than or equal to the sample time period with merchants being designated in one or more of the following merchant categories: retail, restaurant, utility, recreation, entertainment, or any combination thereof; comparing, with at least one processor, the total number of transactions to a predetermined threshold count; and based at least partially on the comparison, designating the financial device as a target financial device of the at least one target financial device.

According to one preferred and non-limiting embodiment or aspect, provided is a computer-implemented method for identifying and communicatively targeting financial devices to promote recurring transactions. The method includes (a) receiving, with at least one processor, financial device data for a plurality of transactions associated with a plurality of financial devices over a sample time period. The financial device data includes at least one of the following parameters for each financial device of the plurality of financial devices: transaction time, transaction count, transaction amount, merchant category, transaction type, or any combination thereof. The method also includes (b) identifying, with at least one processor, at least one target financial device from the financial device data based at least partially on at least one of the parameters having a value in a specified range for the at least one parameter, the value at least partially correlated with a propensity of the at least one target financial device to engage in recurring transactions. The method further includes (c) determining, with at least one processor, at least one reactive financial device holder associated with the at least one identified target financial device that engaged in new recurring transactions during a second sample time period. The method further includes (d) based at least partially on the determination of at least one reactive financial device holder, implementing at least one of the following steps: adding a new parameter to the at least one parameter, removing a parameter from the at least one parameter, modifying the specified range for the at least one parameter, or any combination thereof.

In further preferred and non-limiting embodiments or aspects, the computer-implemented method may include repeating steps (b) through (d) at predefined intervals.

In further preferred and non-limiting embodiments or aspects, the financial device data may include at least the transaction time parameter, and the identification in step (b) may include, for each financial device: determining, with at least one processor, a transaction time of a most recent transaction completed by the financial device; determining, with at least one processor, a current time; comparing, with at least one processor, the transaction time of the most recent transaction to the current time; and based at least partially on the comparison, designating the financial device as a target financial device of the at least one target financial device.

In further preferred and non-limiting embodiments or aspects, the financial device data may include at least the transaction type parameter, and the identification in step (b) may include, for each financial device: determining, with at least one processor, a number of transactions completed online in a period of time less than or equal to the sample time period; comparing, with at least one processor, the number of transactions completed online to a predetermined threshold count; and based at least partially on the comparison, designating the financial device as a target financial device of the at least one target financial device.

In further preferred and non-limiting embodiments or aspects, the financial device data may include at least the transaction type parameter, and the identification in step (b) may include, for each financial device: determining, with at least one processor, a number of face-to-face transactions completed in a period of time less than or equal to the sample time period; comparing, with at least one processor, the number of face-to-face transactions completed to a predetermined threshold count; and based at least partially on the comparison, designating the financial device as a target financial device of the at least one target financial device.

In further preferred and non-limiting embodiments or aspects, the financial device data may include at least the transaction amount parameter, and the identification in step (b) may include, for each financial device: determining, with at least one processor, a total transaction amount for all transactions completed in a period of time less than or equal to the sample time period; comparing, with at least one processor, the total transaction amount to a predetermined threshold amount; and based at least partially on the comparison, designating the financial device as a target financial device of the at least one target financial device.

In further preferred and non-limiting embodiments or aspects, the financial device data may include at least the merchant category parameter, and the identification in step (b) may include, for each financial device: determining, with at least one processor, a total number of transactions completed in a period of time less than or equal to the sample time period with merchants being designated in one or more of the following merchant categories: retail, restaurant, utility, recreation, entertainment, or any combination thereof; comparing, with at least one processor, the total number of transactions to a predetermined threshold count; and based at least partially on the comparison, designating the financial device as a target financial device of the at least one target financial device.

According to one preferred and non-limiting embodiment or aspect, provided is a computer-implemented method for identifying and communicatively targeting financial devices to promote recurring transactions. The method includes (a) receiving, with at least one processor, financial device data for a plurality of transactions associated with a plurality of financial devices over a sample time period. The financial device data includes at least one of the following parameters for each financial device of the plurality of financial devices: transaction time, transaction count, transaction amount, merchant category, transaction type, or any combination thereof. The method also includes (b) generating, with at least one processor, a predictive model based at least partially on the financial device data. The method further includes (c) determining, at least partially on the predictive model, at least one key parameter correlated with increased incidences of recurring transactions by financial device holders. The method further includes (d) identifying, with at least one processor, at least one target financial device from the financial device data based at least partially on the at least one key parameter of the at least one target financial device having a value in a specified range for the at least one key parameter. The method further includes (e) receiving, with at least one processor, identification data of at least one target financial device holder associated with the at least one identified target financial device. The method further includes (f) automatically generating and transmitting at least one communication to the at least one target financial device holder.

In further preferred and non-limiting embodiments or aspects, the predictive model may be generated based on financial device data from a first time range of the sample time period and may be validated at least partially on financial device data from a second time range of the sample time period. The validation may include applying, with at least one processor, the generated predictive model to the financial device data from the second time range. The validation may also include determining, with at least one processor, a confidence score of the predictive model as applied to the financial device data from the second time range. The validation may further include modifying, with at least one processor, the predictive model based at least partially on the confidence score.

According to one preferred and non-limiting embodiment or aspect, provided is a system for identifying and communicatively targeting financial devices to promote recurring transactions. The system includes at least one server computer including at least one processor. The at least one server computer is programmed and/or configured to (a) receive financial device data for a plurality of transactions associated with a plurality of financial devices over a sample time period. The financial device data includes at least one of the following parameters for each financial device of the plurality of financial devices: transaction time, transaction count, transaction amount, merchant category, transaction type, or any combination thereof. The at least one server computer is also programmed and/or configured to (b) identify at least one target financial device from the financial device data based at least partially on at least one of the parameters having a value in a specified range for the at least one parameter, the value at least partially correlated with a propensity of the at least one target financial device to engage in recurring transactions. The at least one server computer is further programmed and/or configured to (c) receive identification data of at least one target financial device holder associated with the at least one identified target financial device. The at least one server computer is further programmed and/or configured to (d) automatically generate and transmit at least one communication to the at least one target financial device holder.

In further preferred and non-limiting embodiments or aspects, the at least one server computer may be further programmed and/or configured to (e) determine at least one reactive financial device holder from the at least one target financial device holder that engaged in at least one new recurring transaction during a second sample time period. The at least one server computer may also be programmed and/or configured to (f) based at least partially on the determination of the at least one reactive financial device holder, modify a method of communication with the at least one target financial device holder. The at least one server computer may be further programmed and/or configured to repeat steps (b) through (f) at predefined intervals.

In further preferred and non-limiting embodiments or aspects, the financial device data may include at least the transaction time parameter, and the identification in step (b) may include, for each financial device: determine a transaction time of a most recent transaction completed by the financial device; determine a current time; compare the transaction time of the most recent transaction to the current time; and based at least partially on the comparison, designate the financial device as a target financial device of the at least one target financial device.

In further preferred and non-limiting embodiments or aspects, the financial device data may include at least the transaction type parameter, and the identification in step (b) may include, for each financial device: determine a number of transactions completed online in a period of time less than or equal to the sample time period; compare the number of transactions completed online to a predetermined threshold count; and based at least partially on the comparison, designate the financial device as a target financial device of the at least one target financial device.

In further preferred and non-limiting embodiments or aspects, the financial device data may include at least the transaction type parameter, and the identification in step (b) may include, for each financial device: determine a number of face-to-face transactions completed in a period of time less than or equal to the sample time period; compare the number of face-to-face transactions completed to a predetermined threshold count; and based at least partially on the comparison, designate the financial device as a target financial device of the at least one target financial device.

In further preferred and non-limiting embodiments or aspects, the financial device data may include at least the transaction amount parameter, and the identification in step (b) may include, for each financial device: determine a total transaction amount for all transactions completed in a period of time less than or equal to the sample time period; compare the total transaction amount to a predetermined threshold amount; and based at least partially on the comparison, designate the financial device as a target financial device of the at least one target financial device.

In further preferred and non-limiting embodiments or aspects, the financial device data may include at least the merchant category parameter, and the identification in step (b) may include, for each financial device: determine a total number of transactions completed in a period of time less than or equal to the sample time period with merchants being designated in one or more of the following merchant categories: retail, restaurant, utility, recreation, entertainment, or any combination thereof; compare the total number of transactions to a predetermined threshold count; and based at least partially on the comparison, designate the financial device as a target financial device of the at least one target financial device.

According to one preferred and non-limiting embodiment or aspect, provided is a system for identifying and communicatively targeting financial devices to promote recurring transactions. The system includes at least one server computer including at least one processor. The at least one server computer is programmed and/or configured to (a) receive financial device data for a plurality of transactions associated with a plurality of financial devices over a sample time period. The financial device data including at least one of the following parameters for each financial device of the plurality of financial devices: transaction time, transaction count, transaction amount, merchant category, transaction type, or any combination thereof. The at least one server computer is also programmed and/or configured to (b) identify at least one target financial device from the financial device data based at least partially on at least one of the parameters having a value in a specified range for the at least one parameter, the value at least partially correlated with a propensity of the at least one target financial device to engage in recurring transactions. The at least one server computer is further programmed and/or configured to (c) determine at least one reactive financial device holder associated with the at least one identified target financial device that engaged in new recurring transactions during a second sample time period. The at least one server computer is further programmed and/or configured to (d) based at least partially on the determination of at least one reactive financial device holder, implement at least one of the following steps: add a new parameter to the at least one parameter, remove a parameter from the at least one parameter, modify the specified range for the at least one parameter, or any combination thereof.

In further preferred and non-limiting embodiments or aspects, the at least one server computer may be programmed and/or configured to repeat steps (b) through (d) at predefined intervals.

In further preferred and non-limiting embodiments or aspects, the financial device data may include at least the transaction time parameter, and the identification in step (b) may include, for each financial device: determine a transaction time of a most recent transaction completed by the financial device; determine a current time; compare the transaction time of the most recent transaction to the current time; and based at least partially on the comparison, designate the financial device as a target financial device of the at least one target financial device.

In further preferred and non-limiting embodiments or aspects, the financial device data may include at least the transaction type parameter, and the identification in step (b) may include, for each financial device: determine a number of transactions completed online in a period of time less than or equal to the sample time period; compare the number of transactions completed online to a predetermined threshold count; and based at least partially on the comparison, designate the financial device as a target financial device of the at least one target financial device.

In further preferred and non-limiting embodiments or aspects, the financial device data may include at least the transaction type parameter, and the identification in step (b) may include, for each financial device: determine a number of face-to-face transactions completed in a period of time less than or equal to the sample time period; compare the number of face-to-face transactions completed to a predetermined threshold count; and based at least partially on the comparison, designate the financial device as a target financial device of the at least one target financial device.

In further preferred and non-limiting embodiments or aspects, the financial device data may include at least the transaction amount parameter, and the identification in step (b) may include, for each financial device: determine a total transaction amount for all transactions completed in a period of time less than or equal to the sample time period; compare the total transaction amount to a predetermined threshold amount; and based at least partially on the comparison, designate the financial device as a target financial device of the at least one target financial device.

In further preferred and non-limiting embodiments or aspects, the financial device data may include at least the merchant category parameter, and the identification in step (b) may include, for each financial device: determine a total number of transactions completed in a period of time less than or equal to the sample time period with merchants being designated in one or more of the following merchant categories: retail, restaurant, utility, recreation, entertainment, or any combination thereof; compare the total number of transactions to a predetermined threshold count; and based at least partially on the comparison, designate the financial device as a target financial device of the at least one target financial device.

According to one preferred and non-limiting embodiment or aspect, provided is a system for identifying and communicatively targeting financial devices to promote recurring transactions. The system includes at least one server computer including at least one processor. The at least one server computer is programmed and/or configured to: (a) receive financial device data for a plurality of transactions associated with a plurality of financial devices over a sample time period. The financial device data includes at least one of the following parameters for each financial device of the plurality of financial devices: transaction time, transaction count, transaction amount, merchant category, transaction type, or any combination thereof. The at least one server computer is also programmed and/or configured to (b) generate a predictive model based at least partially on the financial device data. The at least one server computer is further programmed and/or configured to (c) determine, at least partially on the predictive model, at least one key parameter correlated with increased incidences of recurring transactions by financial device holders. The at least one server computer is further programmed and/or configured to (d) identify at least one target financial device from the financial device data based at least partially on the at least one key parameter of the at least one target financial device having a value in a specified range for the at least one key parameter. The at least one server computer is further programmed and/or configured to (e) receive identification data of at least one target financial device holder associated with the at least one identified target financial device. The at least one server computer is further programmed and/or configured to (f) automatically generate and transmit at least one communication to the at least one target financial device holder.

In further preferred and non-limiting embodiments or aspects, the predictive model may be generated based on financial device data from a first time range of the sample time period and may be validated at least partially on financial device data from a second time range of the sample time period, wherein the at least one server computer may be further programmed and/or configured to apply the generated predictive model to the financial device data from the second time range. The at least one server computer may be further programmed and/or configured to determine a confidence score of the predictive model as applied to the financial device data from the second time range. The at least one server computer may be further programmed and/or configured to modify the predictive model based at least partially on the confidence score.

According to one preferred and non-limiting embodiment or aspect, provided is a computer program product for identifying and communicatively targeting financial devices to promote recurring transactions. The computer program product includes at least one non-transitory computer-readable medium including program instructions. The program instructions, when executed by at least one processor, cause the at least one processor to (a) receive financial device data for a plurality of transactions associated with a plurality of financial devices over a sample time period. The financial device data includes at least one of the following parameters for each financial device of the plurality of financial devices: transaction time, transaction count, transaction amount, merchant category, transaction type, or any combination thereof. The program instructions also cause the at least one processor to (b) identify at least one target financial device from the financial device data based at least partially on at least one of the parameters having a value in a specified range for the at least one parameter, the value at least partially correlated with a propensity of the at least one target financial device to engage in recurring transactions. The program instructions further cause the at least one processor to (c) receive identification data of at least one target financial device holder associated with the at least one identified target financial device and (d) automatically generate and transmit at least one communication to the at least one target financial device holder.

In further preferred and non-limiting embodiments or aspects, the program instructions may cause the at least one processor to (e) determine at least one reactive financial device holder from the at least one target financial device holder that engaged in at least one new recurring transaction during a second sample time period. The program instructions may also cause the at least one processor to (f) based at least partially on the determination of the at least one reactive financial device holder, modify a method of communication with the at least one target financial device holder. The program instructions may further cause the at least one processor to repeat steps (b) through (f) at predefined intervals.

In further preferred and non-limiting embodiments or aspects, the financial device data may include at least the transaction time parameter, and the identification in step (b) may include, for each financial device: determine a transaction time of a most recent transaction completed by the financial device; determine a current time; compare the transaction time of the most recent transaction to the current time; and based at least partially on the comparison, designate the financial device as a target financial device of the at least one target financial device.

In further preferred and non-limiting embodiments or aspects, the financial device data may include at least the transaction type parameter, and the identification in step (b) may include, for each financial device: determine a number of transactions completed online in a period of time less than or equal to the sample time period; compare the number of transactions completed online to a predetermined threshold count; and based at least partially on the comparison, designate the financial device as a target financial device of the at least one target financial device.

In further preferred and non-limiting embodiments or aspects, the financial device data may include at least the transaction type parameter, and the identification in step (b) may include, for each financial device: determine a number of face-to-face transactions completed in a period of time less than or equal to the sample time period; compare the number of face-to-face transactions completed to a predetermined threshold count; and based at least partially on the comparison, designate the financial device as a target financial device of the at least one target financial device.

In further preferred and non-limiting embodiments or aspects, the financial device data may include at least the transaction amount parameter, and the identification in step (b) may include, for each financial device: determine a total transaction amount for all transactions completed in a period of time less than or equal to the sample time period; compare the total transaction amount to a predetermined threshold amount; and based at least partially on the comparison, designate the financial device as a target financial device of the at least one target financial device.

In further preferred and non-limiting embodiments or aspects, the financial device data may include at least the merchant category parameter, and the identification in step (b) may include, for each financial device: determine a total number of transactions completed in a period of time less than or equal to the sample time period with merchants being designated in one or more of the following merchant categories: retail, restaurant, utility, recreation, entertainment, or any combination thereof; compare the total number of transactions to a predetermined threshold count; and based at least partially on the comparison, designate the financial device as a target financial device of the at least one target financial device.

According to one preferred and non-limiting embodiment or aspect, provided is a computer program product for identifying and communicatively targeting financial devices to promote recurring transactions. The computer program product includes at least one non-transitory computer-readable medium including program instructions. The program instructions, when executed by at least one processor, cause the at least one processor to (a) receive financial device data for a plurality of transactions associated with a plurality of financial devices over a sample time period. The financial device data includes at least one of the following parameters for each financial device of the plurality of financial devices: transaction time, transaction count, transaction amount, merchant category, transaction type, or any combination thereof. The program instructions also cause the at least one processor to (b) identify at least one target financial device from the financial device data based at least partially on at least one of the parameters having a value in a specified range for the at least one parameter, the value at least partially correlated with a propensity of the at least one target financial device to engage in recurring transactions. The program instructions further cause the at least one processor to (c) determine at least one reactive financial device holder associated with the at least one identified target financial device that engaged in new recurring transactions during a second sample time period. The program instructions further cause the at least one processor to (d) based at least partially on the determination of at least one reactive financial device holder, implement at least one of the following steps: add a new parameter to the at least one parameter, remove a parameter from the at least one parameter, modify the specified range for the at least one parameter, or any combination thereof.

In further preferred and non-limiting embodiments or aspects, the program instructions may cause the at least one processor to repeat steps (b) through (d) at predefined intervals.

In further preferred and non-limiting embodiments or aspects, the financial device data may include at least the transaction time parameter, and the identification in step (b) may include, for each financial device: determine a transaction time of a most recent transaction completed by the financial device; determine a current time; compare the transaction time of the most recent transaction to the current time; and based at least partially on the comparison, designate the financial device as a target financial device of the at least one target financial device.

In further preferred and non-limiting embodiments or aspects, the financial device data may include at least the transaction type parameter, and the identification in step (b) may include, for each financial device: determine a number of transactions completed online in a period of time less than or equal to the sample time period; compare the number of transactions completed online to a predetermined threshold count; and based at least partially on the comparison, designate the financial device as a target financial device of the at least one target financial device.

In further preferred and non-limiting embodiments or aspects, the financial device data may include at least the transaction type parameter, and the identification in step (b) may include, for each financial device: determine a number of face-to-face transactions completed in a period of time less than or equal to the sample time period; compare the number of face-to-face transactions completed to a predetermined threshold count; and based at least partially on the comparison, designate the financial device as a target financial device of the at least one target financial device.

In further preferred and non-limiting embodiments or aspects, the financial device data may include at least the transaction amount parameter, and the identification in step (b) may include, for each financial device: determine a total transaction amount for all transactions completed in a period of time less than or equal to the sample time period; compare the total transaction amount to a predetermined threshold amount; and based at least partially on the comparison, designate the financial device as a target financial device of the at least one target financial device.

In further preferred and non-limiting embodiments or aspects, the financial device data may include at least the merchant category parameter, and the identification in step (b) may include, for each financial device: determine a total number of transactions completed in a period of time less than or equal to the sample time period with merchants being designated in one or more of the following merchant categories: retail, restaurant, utility, recreation, entertainment, or any combination thereof; compare the total number of transactions to a predetermined threshold count; and based at least partially on the comparison, designate the financial device as a target financial device of the at least one target financial device.

According to one preferred and non-limiting embodiment or aspect, provided is a computer program product for identifying and communicatively targeting financial devices to promote recurring transactions. The computer program product includes at least one non-transitory computer-readable medium including program instructions. The program instructions, when executed by at least one processor, cause the at least one processor to (a) receive financial device data for a plurality of transactions associated with a plurality of financial devices over a sample time period. The financial device data includes at least one of the following parameters for each financial device of the plurality of financial devices: transaction time, transaction count, transaction amount, merchant category, transaction type, or any combination thereof. The program instructions also cause the at least one processor to (b) generate a predictive model based at least partially on the financial device data. The program instructions further cause the at least one processor to (c) determine, at least partially on the predictive model, at least one key parameter correlated with increased incidences of recurring transactions by financial device holders. The program instructions further cause the at least one processor to (d) identify at least one target financial device from the financial device data based at least partially on the at least one key parameter of the at least one target financial device having a value in a specified range for the at least one key parameter. The program instructions further cause the at least one processor to (e) receive identification data of at least one target financial device holder associated with the at least one identified target financial device, and (f) automatically generate and transmit at least one communication to the at least one target financial device holder.

In further preferred and non-limiting embodiments or aspects, the predictive model may be generated based on financial device data from a first time range of the sample time period and validated at least partially on financial device data from a second time range of the sample time period. The program instructions may further cause the at least one processor to: apply the generated predictive model to the financial device data from the second time range; determine a confidence score of the predictive model as applied to the financial device data from the second time range; and modify the predictive model based at least partially on the confidence score.

Other preferred and non-limiting embodiments or aspects of the present invention will be set forth in the following numbered clauses:

Clause 1: A computer-implemented method for identifying and communicatively targeting financial devices to promote recurring transactions, the method comprising: (a) receiving, with at least one processor, financial device data for a plurality of transactions associated with a plurality of financial devices over a sample time period, the financial device data comprising at least one of the following parameters for each financial device of the plurality of financial devices: transaction time, transaction count, transaction amount, merchant category, transaction type, or any combination thereof; (b) identifying, with at least one processor, at least one target financial device from the financial device data based at least partially on at least one of the parameters having a value in a specified range for the at least one parameter, the value at least partially correlated with a propensity of the at least one target financial device to engage in recurring transactions; (c) receiving, with at least one processor, identification data of at least one target financial device holder associated with the at least one identified target financial device; and (d) automatically generating and transmitting at least one communication to the at least one target financial device holder.

Clause 2: The computer-implemented method of clause 1, further comprising: (e) determining, with at least one processor, at least one reactive financial device holder from the at least one target financial device holder that engaged in at least one new recurring transaction during a second sample time period; and (f) based at least partially on the determination of the at least one reactive financial device holder, modifying a method of communication with the at least one target financial device holder.

Clause 3: The computer-implemented method of clause 1 or 2, further comprising repeating steps (b) through (f) at predefined intervals.

Clause 4: The computer-implemented method of any of clauses 1-3, wherein the financial device data comprises at least the transaction time parameter, and the identification in step (b) comprises, for each financial device: determining, with at least one processor, a transaction time of a most recent transaction completed by the financial device; determining, with at least one processor, a current time; comparing, with at least one processor, the transaction time of the most recent transaction to the current time; and based at least partially on the comparison, designating the financial device as a target financial device of the at least one target financial device.

Clause 5: The computer-implemented method of any of clauses 1-4, wherein the financial device data comprises at least the transaction type parameter, and the identification in step (b) comprises, for each financial device: determining, with at least one processor, a number of transactions completed online in a period of time less than or equal to the sample time period; comparing, with at least one processor, the number of transactions completed online to a predetermined threshold count; and based at least partially on the comparison, designating the financial device as a target financial device of the at least one target financial device.

Clause 6: The computer-implemented method of any of clauses 1-5, wherein the financial device data comprises at least the transaction type parameter, and the identification in step (b) comprises, for each financial device: determining, with at least one processor, a number of face-to-face transactions completed in a period of time less than or equal to the sample time period; comparing, with at least one processor, the number of face-to-face transactions completed to a predetermined threshold count; and based at least partially on the comparison, designating the financial device as a target financial device of the at least one target financial device.

Clause 7: The computer-implemented method of any of clauses 1-6, wherein the financial device data comprises at least the transaction amount parameter, and the identification in step (b) comprises, for each financial device: determining, with at least one processor, a total transaction amount for all transactions completed in a period of time less than or equal to the sample time period; comparing, with at least one processor, the total transaction amount to a predetermined threshold amount; and based at least partially on the comparison, designating the financial device as a target financial device of the at least one target financial device.

Clause 8: The computer-implemented method of any of clauses 1-7, wherein the financial device data comprises at least the merchant category parameter, and the identification in step (b) comprises, for each financial device: determining, with at least one processor, a total number of transactions completed in a period of time less than or equal to the sample time period with merchants being designated in one or more of the following merchant categories: retail, restaurant, utility, recreation, entertainment, or any combination thereof; comparing, with at least one processor, the total number of transactions to a predetermined threshold count; and based at least partially on the comparison, designating the financial device as a target financial device of the at least one target financial device.

Clause 9: A computer-implemented method for identifying and communicatively targeting financial devices to promote recurring transactions, the method comprising: (a) receiving, with at least one processor, financial device data for a plurality of transactions associated with a plurality of financial devices over a sample time period, the financial device data comprising at least one of the following parameters for each financial device of the plurality of financial devices: transaction time, transaction count, transaction amount, merchant category, transaction type, or any combination thereof; (b) identifying, with at least one processor, at least one target financial device from the financial device data based at least partially on at least one of the parameters having a value in a specified range for the at least one parameter, the value at least partially correlated with a propensity of the at least one target financial device to engage in recurring transactions; (c) determining, with at least one processor, at least one reactive financial device holder associated with the at least one identified target financial device that engaged in new recurring transactions during a second sample time period; and (d) based at least partially on the determination of at least one reactive financial device holder, implementing at least one of the following steps: adding a new parameter to the at least one parameter, removing a parameter from the at least one parameter, modifying the specified range for the at least one parameter, or any combination thereof.

Clause 10: The computer-implemented method of clause 9, further comprising repeating steps (b) through (d) at predefined intervals.

Clause 11: The computer-implemented method of clause 9 or 10, wherein the financial device data comprises at least the transaction time parameter, and the identification in step (b) comprises, for each financial device: determining, with at least one processor, a transaction time of a most recent transaction completed by the financial device; determining, with at least one processor, a current time; comparing, with at least one processor, the transaction time of the most recent transaction to the current time; and based at least partially on the comparison, designating the financial device as a target financial device of the at least one target financial device.

Clause 12: The computer-implemented method of any of clauses 9-11, wherein the financial device data comprises at least the transaction type parameter, and the identification in step (b) comprises, for each financial device: determining, with at least one processor, a number of transactions completed online in a period of time less than or equal to the sample time period; comparing, with at least one processor, the number of transactions completed online to a predetermined threshold count; and based at least partially on the comparison, designating the financial device as a target financial device of the at least one target financial device.

Clause 13: The computer-implemented method of any of clauses 9-12, wherein the financial device data comprises at least the transaction type parameter, and the identification in step (b) comprises, for each financial device: determining, with at least one processor, a number of face-to-face transactions completed in a period of time less than or equal to the sample time period; comparing, with at least one processor, the number of face-to-face transactions completed to a predetermined threshold count; and based at least partially on the comparison, designating the financial device as a target financial device of the at least one target financial device.

Clause 14: The computer-implemented method of any of clauses 9-13, wherein the financial device data comprises at least the transaction amount parameter, and the identification in step (b) comprises, for each financial device: determining, with at least one processor, a total transaction amount for all transactions completed in a period of time less than or equal to the sample time period; comparing, with at least one processor, the total transaction amount to a predetermined threshold amount; and based at least partially on the comparison, designating the financial device as a target financial device of the at least one target financial device.

Clause 15: The computer-implemented method of any of clauses 9-14, wherein the financial device data comprises at least the merchant category parameter, and the identification in step (b) comprises, for each financial device: determining, with at least one processor, a total number of transactions completed in a period of time less than or equal to the sample time period with merchants being designated in one or more of the following merchant categories: retail, restaurant, utility, recreation, entertainment, or any combination thereof; comparing, with at least one processor, the total number of transactions to a predetermined threshold count; and, based at least partially on the comparison, designating the financial device as a target financial device of the at least one target financial device.

Clause 16: A computer-implemented method for identifying and communicatively targeting financial devices to promote recurring transactions, the method comprising: (a) receiving, with at least one processor, financial device data for a plurality of transactions associated with a plurality of financial devices over a sample time period, the financial device data comprising at least one of the following parameters for each financial device of the plurality of financial devices: transaction time, transaction count, transaction amount, merchant category, transaction type, or any combination thereof; (b) generating, with at least one processor, a predictive model based at least partially on the financial device data; (c) determining, at least partially on the predictive model, at least one key parameter correlated with increased incidences of recurring transactions by financial device holders; (d) identifying, with at least one processor, at least one target financial device from the financial device data based at least partially on the at least one key parameter of the at least one target financial device having a value in a specified range for the at least one key parameter; (e) receiving, with at least one processor, identification data of at least one target financial device holder associated with the at least one identified target financial device; and (f) automatically generating and transmitting at least one communication to the at least one target financial device holder.

Clause 17: The computer-implemented method of clause 16, wherein the predictive model is generated based on financial device data from a first time range of the sample time period and is validated at least partially on financial device data from a second time range of the sample time period, the validation comprising: applying, with at least one processor, the generated predictive model to the financial device data from the second time range; determining, with at least one processor, a confidence score of the predictive model as applied to the financial device data from the second time range; and modifying, with at least one processor, the predictive model based at least partially on the confidence score.

Clause 18: A system for identifying and communicatively targeting financial devices to promote recurring transactions, comprising at least one server computer including at least one processor, the at least one server computer programmed and/or configured to: (a) receive financial device data for a plurality of transactions associated with a plurality of financial devices over a sample time period, the financial device data comprising at least one of the following parameters for each financial device of the plurality of financial devices: transaction time, transaction count, transaction amount, merchant category, transaction type, or any combination thereof; (b) identify at least one target financial device from the financial device data based at least partially on at least one of the parameters having a value in a specified range for the at least one parameter, the value at least partially correlated with a propensity of the at least one target financial device to engage in recurring transactions; (c) receive identification data of at least one target financial device holder associated with the at least one identified target financial device; and (d) automatically generate and transmit at least one communication to the at least one target financial device holder.

Clause 19: The system of clause 18, wherein the at least one server computer is further programmed and/or configured to: (e) determine at least one reactive financial device holder from the at least one target financial device holder that engaged in at least one new recurring transaction during a second sample time period; and (f) based at least partially on the determination of the at least one reactive financial device holder, modify a method of communication with the at least one target financial device holder.

Clause 20: The system of clause 18 or 19, wherein the at least one server computer is further programmed and/or configured to repeat steps (b) through (f) at predefined intervals.

Clause 21: The system of any of clauses 18-20, wherein the financial device data comprises at least the transaction time parameter, and the identification in step (b) comprises, for each financial device: determining a transaction time of a most recent transaction completed by the financial device; determining a current time; comparing the transaction time of the most recent transaction to the current time; and based at least partially on the comparison, designating the financial device as a target financial device of the at least one target financial device.

Clause 22: The system of any of clauses 18-21, wherein the financial device data comprises at least the transaction type parameter, and the identification in step (b) comprises, for each financial device: determining a number of transactions completed online in a period of time less than or equal to the sample time period; comparing the number of transactions completed online to a predetermined threshold count; and based at least partially on the comparison, designating the financial device as a target financial device of the at least one target financial device.

Clause 23: The system of any of clauses 18-22, wherein the financial device data comprises at least the transaction type parameter, and the identification in step (b) comprises, for each financial device: determining a number of face-to-face transactions completed in a period of time less than or equal to the sample time period; comparing the number of face-to-face transactions completed to a predetermined threshold count; and based at least partially on the comparison, designating the financial device as a target financial device of the at least one target financial device.

Clause 24: The system of any of clauses 18-23, wherein the financial device data comprises at least the transaction amount parameter, and the identification in step (b) comprises, for each financial device: determining a total transaction amount for all transactions completed in a period of time less than or equal to the sample time period; comparing the total transaction amount to a predetermined threshold amount; and based at least partially on the comparison, designating the financial device as a target financial device of the at least one target financial device.

Clause 25: The system of any of clauses 18-24, wherein the financial device data comprises at least the merchant category parameter, and the identification in step (b) comprises, for each financial device: determining a total number of transactions completed in a period of time less than or equal to the sample time period with merchants being designated in one or more of the following merchant categories: retail, restaurant, utility, recreation, entertainment, or any combination thereof; comparing the total number of transactions to a predetermined threshold count; and based at least partially on the comparison, designating the financial device as a target financial device of the at least one target financial device.

Clause 26: A system for identifying and communicatively targeting financial devices to promote recurring transactions, comprising at least one server computer including at least one processor, the at least one server computer programmed and/or configured to: (a) receive financial device data for a plurality of transactions associated with a plurality of financial devices over a sample time period, the financial device data comprising at least one of the following parameters for each financial device of the plurality of financial devices: transaction time, transaction count, transaction amount, merchant category, transaction type, or any combination thereof; (b) identify at least one target financial device from the financial device data based at least partially on at least one of the parameters having a value in a specified range for the at least one parameter, the value at least partially correlated with a propensity of the at least one target financial device to engage in recurring transactions; (c) determine at least one reactive financial device holder associated with the at least one identified target financial device that engaged in new recurring transactions during a second sample time period; and (d) based at least partially on the determination of at least one reactive financial device holder, implement at least one of the following steps: add a new parameter to the at least one parameter, remove a parameter from the at least one parameter, modify the specified range for the at least one parameter, or any combination thereof.

Clause 27: The system of clause 26, wherein the at least one server computer is further programmed and/or configured to repeat steps (b) through (d) at predefined intervals.

Clause 28: The system of clause 26 or 27, wherein the financial device data comprises at least the transaction time parameter, and the identification in step (b) comprises, for each financial device: determining a transaction time of a most recent transaction completed by the financial device; determining a current time; comparing the transaction time of the most recent transaction to the current time; and based at least partially on the comparison, designating the financial device as a target financial device of the at least one target financial device.

Clause 29: The system of any of clauses 26-28, wherein the financial device data comprises at least the transaction type parameter, and the identification in step (b) comprises, for each financial device: determining a number of transactions completed online in a period of time less than or equal to the sample time period; comparing the number of transactions completed online to a predetermined threshold count; and based at least partially on the comparison, designating the financial device as a target financial device of the at least one target financial device.

Clause 30: The system of any of clauses 26-29, wherein the financial device data comprises at least the transaction type parameter, and the identification in step (b) comprises, for each financial device: determining a number of face-to-face transactions completed in a period of time less than or equal to the sample time period; comparing the number of face-to-face transactions completed to a predetermined threshold count; and based at least partially on the comparison, designating the financial device as a target financial device of the at least one target financial device.

Clause 31: The system of any of clauses 26-30, wherein the financial device data comprises at least the transaction amount parameter, and the identification in step (b) comprises, for each financial device: determining a total transaction amount for all transactions completed in a period of time less than or equal to the sample time period; comparing the total transaction amount to a predetermined threshold amount; and based at least partially on the comparison, designating the financial device as a target financial device of the at least one target financial device.

Clause 32: The system of any of clauses 26-31, wherein the financial device data comprises at least the merchant category parameter, and the identification in step (b) comprises, for each financial device: determining a total number of transactions completed in a period of time less than or equal to the sample time period with merchants being designated in one or more of the following merchant categories: retail, restaurant, utility, recreation, entertainment, or any combination thereof; comparing the total number of transactions to a predetermined threshold count; and based at least partially on the comparison, designating the financial device as a target financial device of the at least one target financial device.

Clause 33: A system for identifying and communicatively targeting financial devices to promote recurring transactions, comprising at least one server computer including at least one processor, the at least one server computer programmed and/or configured to: (a) receive financial device data for a plurality of transactions associated with a plurality of financial devices over a sample time period, the financial device data comprising at least one of the following parameters for each financial device of the plurality of financial devices: transaction time, transaction count, transaction amount, merchant category, transaction type, or any combination thereof; (b) generate a predictive model based at least partially on the financial device data; (c) determine, at least partially on the predictive model, at least one key parameter correlated with increased incidences of recurring transactions by financial device holders; (d) identify at least one target financial device from the financial device data based at least partially on the at least one key parameter of the at least one target financial device having a value in a specified range for the at least one key parameter; (e) receive identification data of at least one target financial device holder associated with the at least one identified target financial device; and (f) automatically generate and transmit at least one communication to the at least one target financial device holder.

Clause 34: The system of clause 33, wherein the predictive model is generated based on financial device data from a first time range of the sample time period and is validated at least partially on financial device data from a second time range of the sample time period, wherein the at least one server computer is further programmed and/or configured to: apply the generated predictive model to the financial device data from the second time range; determine a confidence score of the predictive model as applied to the financial device data from the second time range; and modify the predictive model based at least partially on the confidence score.

Clause 35: A computer program product for identifying and communicatively targeting financial devices to promote recurring transactions, comprising at least one non-transitory computer-readable medium including program instructions that, when executed by at least one processor, cause the at least one processor to: (a) receive financial device data for a plurality of transactions associated with a plurality of financial devices over a sample time period, the financial device data comprising at least one of the following parameters for each financial device of the plurality of financial devices: transaction time, transaction count, transaction amount, merchant category, transaction type, or any combination thereof; (b) identify at least one target financial device from the financial device data based at least partially on at least one of the parameters having a value in a specified range for the at least one parameter, the value at least partially correlated with a propensity of the at least one target financial device to engage in recurring transactions; (c) receive identification data of at least one target financial device holder associated with the at least one identified target financial device; and (d) automatically generate and transmit at least one communication to the at least one target financial device holder.

Clause 36: The computer program product of clause 35, wherein the program instructions further cause the at least one processor to: (e) determine at least one reactive financial device holder from the at least one target financial device holder that engaged in at least one new recurring transaction during a second sample time period; and (f) based at least partially on the determination of the at least one reactive financial device holder, modify a method of communication with the at least one target financial device holder.

Clause 37: The computer program product of clause 35 or 36, wherein the program instructions further cause the at least one processor to repeat steps (b) through (f) at predefined intervals.

Clause 38: The computer program product of any of clauses 35-37, wherein the financial device data comprises at least the transaction time parameter, and the identification in step (b) comprises, for each financial device: determining a transaction time of a most recent transaction completed by the financial device; determining a current time; comparing the transaction time of the most recent transaction to the current time; and based at least partially on the comparison, designating the financial device as a target financial device of the at least one target financial device.

Clause 39: The computer program product of any of clauses 35-38, wherein the financial device data comprises at least the transaction type parameter, and the identification in step (b) comprises, for each financial device: determining a number of transactions completed online in a period of time less than or equal to the sample time period; comparing the number of transactions completed online to a predetermined threshold count; and based at least partially on the comparison, designating the financial device as a target financial device of the at least one target financial device.

Clause 40: The computer program product of any of clauses 35-39, wherein the financial device data comprises at least the transaction type parameter, and the identification in step (b) comprises, for each financial device: determining a number of face-to-face transactions completed in a period of time less than or equal to the sample time period; comparing the number of face-to-face transactions completed to a predetermined threshold count; and based at least partially on the comparison, designating the financial device as a target financial device of the at least one target financial device.

Clause 41: The computer program product of any of clauses 35-40, wherein the financial device data comprises at least the transaction amount parameter, and the identification in step (b) comprises, for each financial device: determining a total transaction amount for all transactions completed in a period of time less than or equal to the sample time period; comparing the total transaction amount to a predetermined threshold amount; and based at least partially on the comparison, designating the financial device as a target financial device of the at least one target financial device.

Clause 42: The computer program product of any of clauses 35-41, wherein the financial device data comprises at least the merchant category parameter, and the identification in step (b) comprises, for each financial device: determining a total number of transactions completed in a period of time less than or equal to the sample time period with merchants being designated in one or more of the following merchant categories: retail, restaurant, utility, recreation, entertainment, or any combination thereof; comparing the total number of transactions to a predetermined threshold count; and based at least partially on the comparison, designating the financial device as a target financial device of the at least one target financial device.

Clause 43: A computer program product for identifying and communicatively targeting financial devices to promote recurring transactions, comprising at least one non-transitory computer-readable medium including program instructions that, when executed by at least one processor, cause the at least one processor to: (a) receive financial device data for a plurality of transactions associated with a plurality of financial devices over a sample time period, the financial device data comprising at least one of the following parameters for each financial device of the plurality of financial devices: transaction time, transaction count, transaction amount, merchant category, transaction type, or any combination thereof; (b) identify at least one target financial device from the financial device data based at least partially on at least one of the parameters having a value in a specified range for the at least one parameter, the value at least partially correlated with a propensity of the at least one target financial device to engage in recurring transactions; (c) determine at least one reactive financial device holder associated with the at least one identified target financial device that engaged in new recurring transactions during a second sample time period; and (d) based at least partially on the determination of at least one reactive financial device holder, implement at least one of the following steps: add a new parameter to the at least one parameter, remove a parameter from the at least one parameter, modify the specified range for the at least one parameter, or any combination thereof.

Clause 44: The computer program product of clause 43, wherein the program instructions further cause the at least one processor to repeat steps (b) through (d) at predefined intervals.

Clause 45: The computer program product of clause 43 or 44, wherein the financial device data comprises at least the transaction time parameter, and the identification in step (b) comprises, for each financial device: determining a transaction time of a most recent transaction completed by the financial device; determining a current time; comparing the transaction time of the most recent transaction to the current time; and based at least partially on the comparison, designating the financial device as a target financial device of the at least one target financial device.

Clause 46: The computer program product of any of clauses 43-45, wherein the financial device data comprises at least the transaction type parameter, and the identification in step (b) comprises, for each financial device: determining a number of transactions completed online in a period of time less than or equal to the sample time period; comparing the number of transactions completed online to a predetermined threshold count; and based at least partially on the comparison, designating the financial device as a target financial device of the at least one target financial device.

Clause 47: The computer program product of any of clauses 43-46, wherein the financial device data comprises at least the transaction type parameter, and the identification in step (b) comprises, for each financial device: determining a number of face-to-face transactions completed in a period of time less than or equal to the sample time period; comparing the number of face-to-face transactions completed to a predetermined threshold count; and based at least partially on the comparison, designating the financial device as a target financial device of the at least one target financial device.

Clause 48: The computer program product of any of clauses 43-47, wherein the financial device data comprises at least the transaction amount parameter, and the identification in step (b) comprises, for each financial device: determining a total transaction amount for all transactions completed in a period of time less than or equal to the sample time period; comparing the total transaction amount to a predetermined threshold amount; and based at least partially on the comparison, designating the financial device as a target financial device of the at least one target financial device.

Clause 49: The computer program product of any of clauses 43-48, wherein the financial device data comprises at least the merchant category parameter, and the identification in step (b) comprises, for each financial device: determining a total number of transactions completed in a period of time less than or equal to the sample time period with merchants being designated in one or more of the following merchant categories: retail, restaurant, utility, recreation, entertainment, or any combination thereof; comparing the total number of transactions to a predetermined threshold count; and based at least partially on the comparison, designating the financial device as a target financial device of the at least one target financial device.

Clause 50: A computer program product for identifying and communicatively targeting financial devices to promote recurring transactions, comprising at least one non-transitory computer-readable medium including program instructions that, when executed by at least one processor, cause the at least one processor to: (a) receive financial device data for a plurality of transactions associated with a plurality of financial devices over a sample time period, the financial device data comprising at least one of the following parameters for each financial device of the plurality of financial devices: transaction time, transaction count, transaction amount, merchant category, transaction type, or any combination thereof; (b) generate a predictive model based at least partially on the financial device data; (c) determine, at least partially on the predictive model, at least one key parameter correlated with increased incidences of recurring transactions by financial device holders; (d) identify at least one target financial device from the financial device data based at least partially on the at least one key parameter of the at least one target financial device having a value in a specified range for the at least one key parameter; (e) receive identification data of at least one target financial device holder associated with the at least one identified target financial device; and (f) automatically generate and transmit at least one communication to the at least one target financial device holder.

Clause 51: The computer program product of claim 50, wherein the predictive model is generated based on financial device data from a first time range of the sample time period and is validated at least partially on financial device data from a second time range of the sample time period, wherein the program instructions further cause the at least one processor to: apply the generated predictive model to the financial device data from the second time range; determine a confidence score of the predictive model as applied to the financial device data from the second time range; and modify the predictive model based at least partially on the confidence score.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details of the invention are explained in greater detail below with reference to the exemplary embodiments that are illustrated in the accompanying schematic figures, in which:

FIG. 1 is a schematic diagram of one embodiment or aspect of a method and system for identifying and communicatively targeting financial devices to promote recurring transactions;

FIG. 2 is a process diagram of one embodiment or aspect of a method and system for identifying and communicatively targeting financial devices to promote recurring transactions;

FIG. 3 is an iterative flow diagram of one embodiment or aspect of a method and system for identifying and communicatively targeting financial devices to promote recurring transactions; and

FIG. 4 is a schematic diagram of one embodiment or aspect of a method and system for identifying and communicatively targeting financial devices to promote recurring transactions.

### DETAILED DESCRIPTION OF THE INVENTION

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific devices and process illustrated in the attached drawings, and described in the following specification, are simply exemplary embodiments of the invention. Hence, specific dimensions and other physical characteristics related to the embodiments disclosed herein are not to be considered as limiting. Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

As used herein, the term “issuer institution” may refer to one or more entities, such as a bank, that provides accounts to customers for conducting payment transactions, such as initiating credit and/or debit payments. For example, an issuer institution may provide an account identifier, such as a personal account number (PAN), to a customer that uniquely identifies one or more accounts associated with that customer. The account identifier may be embodied on a physical financial instrument, such as a payment card, and/or may be electronic and used for electronic payments. As used herein, the term “account identifier” may include one or more PANs, tokens, or other identifiers associated with a customer account. An account identifier may be directly or indirectly associated with an issuer institution, such that an account identifier may be a token that maps to a PAN or other type of account identifier. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifiers in one or more databases such that they can be used to conduct a transaction without directly using the original account identifier. In some examples, an original account identifier, such as a PAN, may be associated with a plurality of tokens for different individuals or purposes. An issuer institution may be associated with a bank identification number (BIN) or other unique identifier that uniquely identifies it among other issuer institutions. The terms “issuer institution,” “issuer bank,” and “issuer system” may also refer to one or more computer systems operated by or on behalf of an issuer institution, such as a server computer executing one or more software applications. For example, an issuer system may include one or more authorization servers for authorizing a payment transaction.

As used herein, the term “merchant” refers to any individual or entity that provides goods, and/or services, or access to goods and/or services, to customers based on a transaction, such as a payment transaction. Merchants may include, but are not limited to, restaurants, food trucks, clubs, gymnasiums, retail stores, professional services providers (e.g., dentists, doctors, plumbers, etc.), parks, museums, attractions, sporting venues, and/or the like. It will be appreciated that numerous other types of merchants are within the scope of this invention.

As used herein, the term “financial device” may refer to a portable (e.g., physical) payment card, a gift card, a smartcard, a smart media, a payroll card, a healthcare card, a wrist band, a machine-readable medium containing account information, a keychain device, a supermarket discount card, a cellular phone, a mobile device, a personal digital assistant, a pager, a security card, a computer, an access card, a wireless terminal, or a transponder. The financial device may include a volatile or a non-volatile memory to store information, such as the account number or a name of the account holder. The term “financial device” may also refer to any unique identifier, physical or digital, associated with a financial transaction account that can be used to complete a transaction between a user of the financial device and another party, such as a merchant. For example, a financial device may be a financial transaction account number and confirmation code that may be entered into an online store payment interface. It will be appreciated that many other configurations and embodiments are possible.

As used herein, the term “merchant system” may refer to one or more server computers, point-of-sale devices, online interfaces, third party hosted services, and/or the like that are used to complete transactions with one or more financial devices. The term merchant system may also refer to one or more server computers, processors, online interfaces, third party hosted services, and/or the like that are used to transmit and/or receive communications with issuer institutions, transaction service providers, transaction processing servers, financial device holders, and/or the like.

As used herein, the term “transaction service provider” may refer to an entity that collects authorization requests from merchants and provides guarantees of payment, in some cases through an agreement between the transaction service provider and an issuer institution. As used herein, the term “recurring transactions” may refer to any series of repeated or patterned transactions between a financial device and a merchant. Recurring transactions are often regular and of a similar amount but do not need to be identical in cost or identical in purchased goods/services to be recurring.

As used herein, the term “mobile device” may refer to one or more portable electronic devices that are configured to communicate with one or more networks. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices.

Non-limiting embodiments or aspects of the present invention are directed to identifying and communicatively targeting financial devices to promote recurring transactions. Embodiments or aspects of the present invention provide a system, including at least one server computer, to receive financial device data and identify target financial devices based on predetermined parameters from a generated predictive model. The system of the present invention provides for automated determination of behavior that is indicative of a propensity to engage in recurring transactions in the future. Also provided is at least one server computer to receive identification data of an associated financial device holder and automatically generate and transmit a communication to the financial device holder. The system has the technical benefit of integrating behavior detection with automated user interaction and communication. Additionally, the interaction and communication can be used to further promote the desired behavior and create a feedback loop to perfect the underlying predictive model. Embodiments or aspects of the present invention improve on tools to identify and target intended financial device holder behavior, particularly by leveraging a network of financial data and holder-issuer-service provider interactions. Furthermore, embodiments or aspects of the present invention provide the tools and systems for iteratively monitoring financial device transactions and modifying the predictive model or methods of communication to further improve on identifying and targeting financial devices.

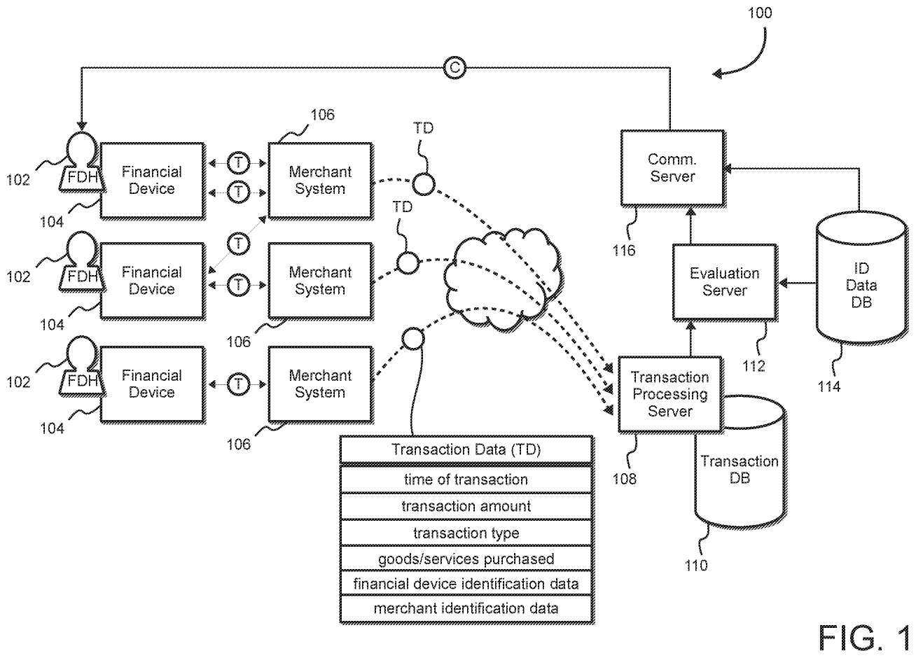

With specific reference to FIG. 1, and in one preferred and non-limiting embodiment or aspect, provided is a method and system 100 for identifying and communicatively targeting financial devices to promote recurring transactions. Provided are financial device holders 102 who are associated with and use financial devices 104 to complete transactions (T) with merchants via merchant systems 106. Each financial device 104 may be associated with one or more financial device holders 102. Likewise, each financial device holder 102 may be associated with one or more financial devices 104. Each financial device 104 may complete transactions (T) with one or more merchant systems 106. Transaction data (TD) that is representative of the transactions (T) with each merchant system 106 is communicated to a transaction processing server 108, which may be associated with an issuer institution or a transaction service provider. The transaction processing server 108 may also be communicatively connected to a transaction database 110, which may store the transaction data (TD). The transaction data (TD) may include a number of parameters of the one or more transactions (T), including, but not limited to: time of transaction, transaction amount, transaction type, goods/services purchased, financial device identification data (e.g., financial device identifier, financial device type, associated financial device holder, financial device locality, etc.), merchant identification data (e.g., merchant category, merchant identifier, merchant location, etc.), and/or the like. The transaction data (TD) may also be grouped or stored relationally to each financial device 104 to generate and/or determine financial device data. Alternatively, financial device data may be generated and/or determined from transaction data (TD) at an evaluation server 112. Financial device data may include one or more of the following parameters for a given financial device 104: times of transactions (T), number of transactions (T), amount of transactions (T), merchant category for transactions (T), types of transactions (T), and/or the like. It will be appreciated that many configurations are possible.

With further reference to FIG. 1, and in a further preferred and non-limiting embodiment or aspect, the transaction processing server 108 is in communication with an evaluation server 112 that has at least one processor to identify at least one financial device 104 having a financial device data parameter in a specified range, the specified range indicative of a propensity to engage in recurring transactions (T) in the future. The transaction processing server 108 may be the same server as the evaluation server 112. The financial device data parameter may be pre-selected for evaluation through automated execution of a predictive model, which may be used to identify one or more key parameters that are correlated with or indicative of a likelihood to engage in recurring transactions (T). If a given financial device 104 has financial device data with a parameter in a specified range, the financial device 104 may be considered a “target” financial device. For example, if the transaction count parameter for a financial device 104 is fifteen transactions in a given sample time period (e.g., a week, a month, a quarter, etc.), and fifteen transactions is within a predetermined specified range (e.g., ten or greater transactions) that the model indicates is correlated with recurrent transaction propensity, the financial device 104 may be designated as a target financial device. The evaluation server 112 may be further communicatively connected to an identification data database 114 to receive identification data of one or more financial device holders 102 associated with an identified target financial device 104. Identification data may include, but is not limited to: financial device holder name, financial device holder email address, financial device holder phone number, financial device holder physical address, financial device holder issuer institution, and/or the like. It will be appreciated that many other types of identification data and configurations are possible.

With further reference to FIG. 1, and in a further preferred and non-limiting embodiment or aspect, the evaluation server 112 transmits to a communication server 116 data of the one or more target financial devices 104. The evaluation server 112 may also communicate the identification data of one or more financial device holders 102 associated with the target financial devices 104. The evaluation server 112 may also be the same server as the communication server 116, and the communication server 116 may be the same server as the transaction processing server 108. In addition to or instead of the evaluation server 112 being in communicative connection with the identification data database 114, the communication server 116 may be communicatively connected to the identification data database 114 to receive identification data of one or more financial device holders 102 associated with an identified target financial device 104. Having received identification data from the evaluation server 112 and/or the identification data database 114, the communication server 116 generates and transmits at least one communication (C) to one or more target financial device holders 102. For example, the communication (C) may be a text-based communication, such as an automatically generated email solicitation encouraging the target financial device holder 102 to use the target financial device 104 for repeated transactions, such as to pay bills, fees, or recurring invoices. By way of further example, the communication (C) may be an issuer institution interface plug-in notification associated with the target financial device 104, such that a target financial device holder 102 is displayed an offer or solicitation to use the financial device 104 for certain types of recurring transactions. The communication (C) may alternatively be an automated action by the issuer institution or transaction service provider to place the financial device holder 102 in an incentive or rewards program, to encourage repeated transactions. Furthermore, a communication (C) may be transmitted to a merchant system 106 with which the target financial device 104 has previously completed a transaction (T), to allow the merchant to direct communications (C) to the target financial device holder 104. Likewise, a communication (C) may be transmitted to an issuer institution through which the financial device 104 was issued, to allow the issuer institution to direct communications (C) to the target financial device holder 102. It will be appreciated that many configurations are possible.

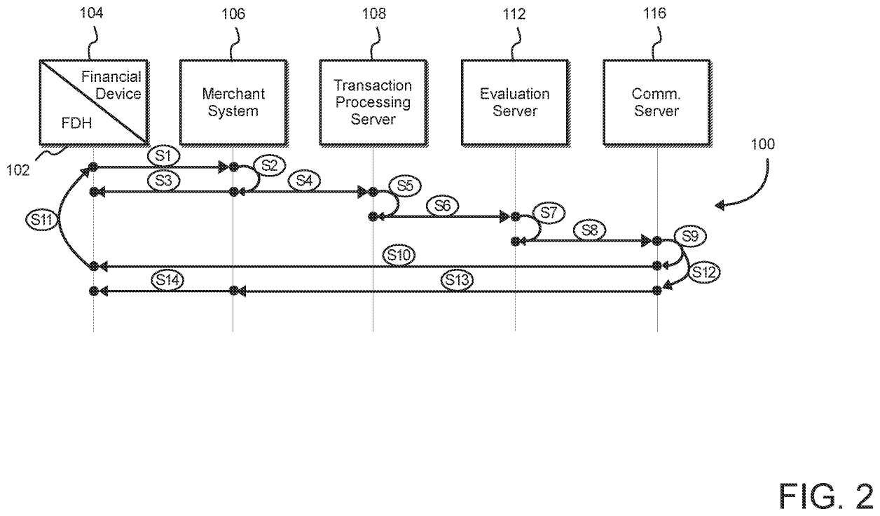

With specific reference to FIG. 2, and in one preferred and non-limiting embodiment or aspect, provided is a method and system 100 for identifying and communicatively targeting financial devices to promote recurring transactions. Given that the method 100 may be a repeated or iterative process, it will be appreciated that the step labels (e.g., “step 1” depicted as S1) are for exemplary purposes to show general order and progression. The method 100 may be initiated at one or more locations in the process. At S1, the method 100 includes a financial device holder 102 completing one or more transactions with a merchant system 106 via a financial device 104. It will be appreciated that, at S1, there may be one or more financial device holders 102 completing one or more transactions with one or more merchant systems 106, using one or more financial devices 104. At S2, the merchant system 106 may analyze the transaction to determine an associated financial device holder 102, the identification data of which may have been provided to the merchant system 106 by the financial device holder 102 or by a communication server 116 that designated the financial device holder 102 as a target for recurring transactions. At S3, the merchant system 106 may communicate a transaction receipt or confirmation to the financial device holder 102, and further, the merchant system 106 may send a communication to the financial device holder 102 to encourage continued use of the associated financial device. At S4, the merchant system 106 may communicate transaction data to a transaction processing server 108, the transaction data representative of the transaction completed during S1. For example, the merchant system 106 (e.g., point-of-sale system, online interface, etc.) may communicate automatically with the transaction processing server 108 in order to complete processing the transaction. At S5, the transaction processing server 108 may store the transaction data in a transaction database, and further, may store the transaction data relationally in association with each financial device to generate and/or determine financial device data, which may be communicated to an evaluation server 112 at S6. Alternatively, financial device data may be generated and/or determined at an evaluation server 112 after receiving transaction data from the transaction processing server 108 at S6. It will be appreciated that the transaction processing server 108 and the evaluation server 112 may be the same server. Many alternative server configurations are possible.

With further reference to FIG. 2, and in a further preferred and non-limiting embodiment or aspect, the evaluation server 112 identifies at S7 at least one financial device 104 as a target financial device 104 having a financial device data parameter in a specified range, the specified range indicative of a propensity to engage in recurring transactions in the future. The financial device data parameter may be pre-selected for evaluation through automated execution of a predictive model, which may be used to identify one or more key parameters that are correlated with or indicative of a likelihood to engage in recurring transactions. One or more financial device holders 102 may be associated with the target financial device 104, which may be determined at S7 based on identification data from an identification data database 114. Data of one or more target financial device holders 102 may then be communicated to a communication server 116 at S8. Alternatively, data of a target financial device 104 may be communicated to a communication server 116 at S8, at which point the communication server 116 may determine an associated financial device holder 102. When one or more target financial device holders 102 are determined, the communication server 116 may generate a communication to the target financial device holders 102 at S9 and transmit the communication to the target financial device holders 102 at S10. The communication may be a message, including text-based communications (e.g., email, SMS, online messaging platforms, etc.), audio-based communications (e.g., voicemail, telephone calls, voice over internet protocol calls, mobile device sound alerts, etc.), video-based communications (e.g., still images, animated images, video files, etc.), or any combination thereof. The communication alternatively may be an automated action or a notification in a user interface for managing the associated financial device 104. At S11, a targeted financial device holder 102 may take an action based on the communication from S10, such as purchasing goods/services, enrolling in an incentive program, completing a survey, selecting rewards, registering for automatic payments, and/or the like. It will be appreciated that many configurations are possible for communications to financial device holders 102, and actions thereon.

With further reference to FIG. 2, and in a further preferred and non-limiting embodiment or aspect, the communication server 116 may generate, in addition to or instead of a communication to the financial device holder 102, a communication to a merchant system 106 at S12, specifically, a merchant system 106 that completed the transaction with a target financial device 104. The communication server 116 may provide identification data of the target financial device holder 102 to the merchant system 106 at S13 to allow the merchant system 106 to send its own communication to the financial device holder 102 at S14. It will be appreciated that the financial device holder 102 may be required to opt in to communications from merchant systems 106 before operating steps S12-S14. Moreover, it will be appreciated that steps S12-S14 may be carried out through an issuer institution instead of a merchant. For example, the communication server 116 may generate a communication at S12 including identification data of the target financial device holder 102. The communication server 116 may then transmit the communication to an issuer institution that issued the target financial device 104. The issuer institution may then transmit its own communication to the target financial device holder 102 to incentivize recurring transactions. It will further be appreciated that communications from the communication server 116 to the financial device holder 102, the merchant system 106, and the issuer institution may be completed independently or in combination. Furthermore, it will be appreciated that the communication server 116 may be the same server as the evaluation server 112 and/or the transaction processing server 108. Other configurations are possible.

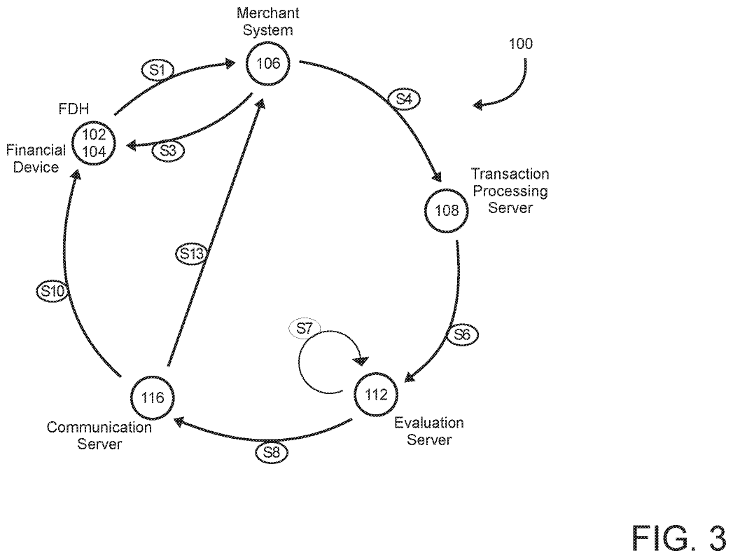

With specific reference to FIG. 3, and in one preferred and non-limiting embodiment or aspect, provided is a method and system 100 for identifying and communicatively targeting financial devices 104 to promote recurring transactions. The method 100 as depicted in FIG. 2 is represented cyclically in FIG. 3, which focuses primarily on the communications within the network and iterative improvement of the method 100 and its models. Given that the method 100 may be a repeated or iterative process, it will be appreciated that the step labels (e.g., “step 1” depicted as S1) are for exemplary purposes to show general order and progression. The method 100 may be initiated at one or more locations in the process. At S1, a financial device holder 102 completes one or more transactions with a merchant system 106 via a financial device 104. It will be appreciated that there may be one or more financial device holders 102 completing one or more transactions with one or more merchant systems 106, using one or more financial devices 104. At S3, the merchant system 106 may communicate a transaction receipt or confirmation to the financial device holder 102, and further, the merchant system 106 may send a communication to the financial device holder 102 to encourage continued use of the associated financial device 104. At S4, the merchant system 106 may communicate transaction data to a transaction processing server 108, the transaction data representative of the transaction completed during S1. For example, the merchant system 106 (e.g., point-of-sale system, online interface, etc.) may communicate automatically with the transaction processing server 108 in order to complete processing the transaction. It will be appreciated that other configurations are possible.

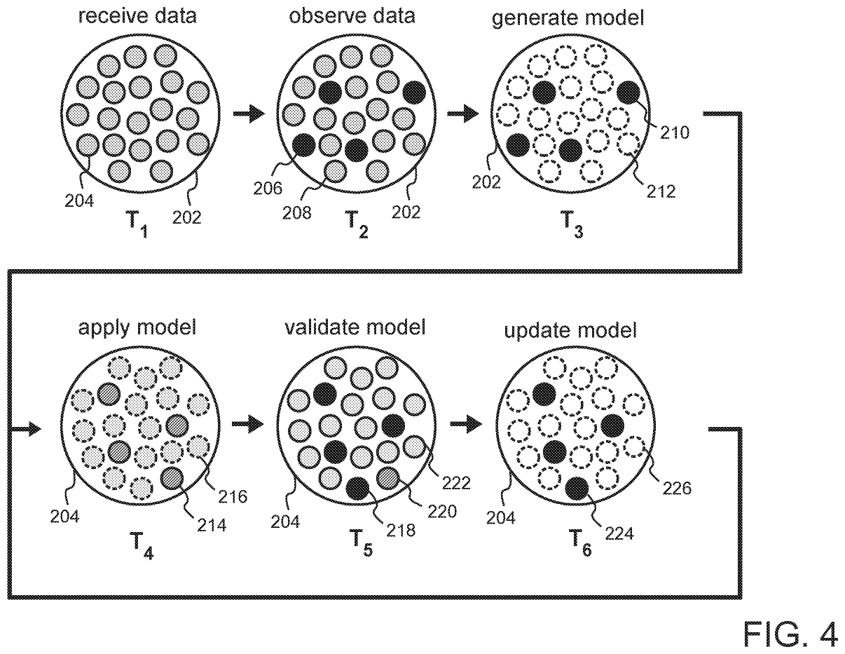

With further reference to FIG. 3, and in a further preferred and non-limiting embodiment or aspect, the transaction processing server 108 may determine financial device data from the transaction data and communicate the financial device data to an evaluation server 112 at S6. Alternatively, financial device data may be determined at the evaluation server 112 after receiving transaction data from the transaction processing server 108 at S6. It will be appreciated that the transaction processing server 108 and the evaluation server 112 may be the same server, and that many configurations are possible for storage of transaction data and determination of financial device data. At S7, the evaluation server 112 identifies at least one financial device 104 as a target financial device 104 having a financial device data parameter in a specified range, the specified range indicative of a propensity to engage in recurring transactions in the future. The financial device data parameter may be pre-selected for evaluation through automated execution of a predictive model, which may be used to identify one or more key parameters that are correlated with or indicative of a likelihood to engage in recurring transactions. The predictive model may be modified at S7, wherein a key parameter may be added or removed, or a range thereof may be changed (e.g., widened, narrowed, increased, decreased, etc.). With continued additional cycles of method 100, and providing for feedback to the evaluation server 112, the predictive model becomes more accurate at identifying target financial devices 104 that are more likely to engage in recurring transactions. Feedback can be provided to the evaluation server 112 through communications directly from financial device holders 102, or by observing merchant transactions, or by receiving reports from issuer institutions. Feedback may be received or generated by the transaction processing server 108, the evaluation server 112, the communication server 116, or any combination thereof. Further discussion of the iterative improvement of the predictive model is discussed in association with FIG. 4. It will be appreciated that many configurations are possible.

With further reference to FIG. 3, and in a further preferred and non-limiting embodiment or aspect, one or more financial device holders 102 may be associated with a target financial device 104, which may be determined at S7 based on identification data from an identification data database 114. One or more target financial device holders 102 may then be communicated to a communication server 116 at S8. Alternatively, a target financial device may be communicated to a communication server 116 at S8, at which point the communication server 116 may determine an associated financial device holder 102. When one or more target financial device holders 102 are determined, the communication server 116 may generate a communication to the target financial device holders 102 and transmit the communication to the target financial device holders 102 at S10. The communication server 116 may also generate, in addition to or instead of a communication to the financial device holder 102, a communication to a merchant system 106, specifically, a merchant system 106 that completed the transaction with a target financial device. The communication server 116 may provide identification data of the target financial device holder 102 to the merchant system 106 at S13 to allow the merchant to send its own communication to the financial device holder 102. It will be appreciated that step S13 may be carried out through an issuer institution instead of a merchant. For example, the communication server 116 may generate a communication including identification data of the target financial device holder 102. The communication server 116 may then transmit the communication to an issuer institution that issued the target financial device 104. The issuer institution may then transmit its own communication to the target financial device holder 102 to incentivize recurring transactions. Furthermore, it will be appreciated that the communication server 116 may be the same server as the evaluation server 112 and/or the transaction processing server 108. Other configurations are possible.

With specific reference to FIG. 4, and in one preferred and non-limiting embodiment or aspect, provided is a process for a predictive model to be used in a computer-implemented method for identifying and communicatively targeting financial devices to promote recurring transactions. The steps in the process are depicted as occurring in sequential times T₁-T₆, by way of example, but it will be appreciated that one or more times or steps of the process may coincide with one or more other times or steps. The predictive model process begins by receiving a set of financial device data 202 at T₁, which includes transaction data from a plurality of transactions from a sample time period (e.g., six months) between one or more financial device holders 102 and one or more merchants. The set of financial devices 202 includes financial device data associated with one or more financial devices 204. At T₂, and over a second sample time period (e.g., a subsequent six months), the set of financial devices 202 is observed to determine positive reactive financial devices 206 (i.e., financial devices that engaged in recurring transactions) and negative reactive financial devices 208 (i.e., financial devices that did not engage in recurring transactions). The predictive model may use any appropriate logic to automatically identify a recurring transaction, such as, but not limited to: computing the median and average spent at each merchant for a financial device, and designating a transaction as a recurring transaction where it meets the following criteria: if 0.75×minimum(average amount spent, median amount spent) transaction amount spent≤1.25×maximum(average amount spent, median amount spent), and there are more than one transaction at the merchant for the financial device. It will be appreciated that other logic definitions of recurring transaction may be employed. At T₃, the set of financial devices 202 is analyzed to determine which parameters of financial devices 204 in T₁ were correlated with the devices 204 becoming positive reactive financial devices 206, (i.e., engaging in recurring transactions) in T₂ (said parameters also referred to herein as “key parameters”). For example, a key parameter may be binary, such as a true-false “preferred device” parameter that indicates when a financial device is a preferred or premium financial device of the issuer institution or transaction service provider. A key parameter may also be categorical, such as a “merchant type” parameter that indicates the types of merchants that participated in transactions with the financial device. A key parameter may also be numerical, such as a “total transaction amount” parameter that indicates the total amount spent in transactions by the financial device. The presence of a key parameter itself, or the values thereof, may be correlated with a propensity to engage in recurring transactions. The correlation of key parameters or their values with engaging in recurring transactions may be identified through deterministic or stochastic statistical analysis (e.g., logistic regression). For a logistic regression application, the state of positively or negatively engaging in recurring transactions may be set as the binary dependent variable, and the transaction data parameters being analyzed may be set as independent variables. Determining the contribution of individual transaction data parameters, and therefore determining key parameters, may be completed through an appropriate statistical coefficient contribution test, such as a likelihood ratio test, a Wald statistic, and/or the like. Evaluating the goodness of fit of the overall model may be completed through deviance tests, likelihood ratio tests, pseudo-R² statistics, and/or the like. It will be appreciated that other statistical relationship models may be employed. From the analysis in T₃, a predictive model is built to identify parameter-correlated financial devices 210. Parameter-correlated financial devices 210 are target financial devices for communications from transaction service providers, issuer institutions, merchants, and/or the like. Parameters or values that are not correlated with engaging in recurring transactions may be ignored, and parameter-uncorrelated financial devices 212 would not be target financial devices for communications from transaction service providers, issuer institutions, merchants, and/or the like.

With further reference to FIG. 4, and in a further preferred and non-limiting embodiment or aspect, the predictive model from T₃ is applied to a second set of financial device data 204 from T₄. Based on the key parameters of the predictive model, certain financial devices are determined to be reactive-likely financial devices 214 (i.e., having parameters or values that are correlated with and indicative of engaging in recurring transactions). Other financial devices are determined to be reactive-unlikely financial devices 216 (i.e., having parameters or values that are not correlated or indicative of engaging in recurring transactions). Reactive-likely financial devices 214 become target financial devices for communications directly from a communication server, or indirectly through merchants or issuer institutions. The second set of financial device data 204 is then observed in T₅ to validate the predictive model as applied in T₄. Reactive financial devices 218 are determined and are analyzed to see which reactive devices were targeted by communications. Model validation determines if a communication or other action increased the likelihood of the target financial devices of engaging in recurring transactions. Non-reactive but targeted financial devices 220 are also noted, to provide corrective feedback to the model, which may indicate that key parameters or value ranges were incorrectly determined. Alternatively, the non-reactive target financial devices 220 may indicate a failure in the communication process. Based at least partly on the model validation in T₅, the model may be updated in T₆ to identify new parameter-correlated financial devices 224 and new parameter-uncorrelated financial devices 226. Key parameters may be added or removed, or values thereof may be modified. After the model is updated, if at all, a new set of financial device data may be collected, and the steps described in T₄-T₆ may be repeated, to iteratively perfect the predictive model and/or the communication process. It will be appreciated that other configurations or orders of operation are possible.

With further reference to the foregoing figures, the above-described predictive model may be applied to financial device data to automatically identify financial devices for targeted communications and/or actions. Key parameters may be identified by the predictive model as indicative of a propensity to engage in recurring transactions. Parameter value ranges for those key parameters may also be determined by application of statistical analysis, as described above. Based on the determined value ranges of the key parameters, one or more processors may automatically determine parameter values for each financial device in the financial device data and determine if those parameters are within the predetermined value ranges, thereby indicating that the financial device is likely to engage in recurring transactions. The one or more processors may carry out this process for one or more parameters, and the designation of a target financial device may be based on one or more parameters.

With further reference to the foregoing figures, and by way of example, a processor may determine all transactions that are associated with a given financial device and determine the time of the most recent transaction. The processor may also determine a current time. The processor may then determine a difference, time span, value, and/or the like in comparing the time of the most recent transaction to the current time. Based at least partially on that comparison, the processor may designate the financial device as a target financial device. For example, application of the predictive model on historic financial device data may determine that financial devices that complete a transaction within a week before observation have a statistically higher likelihood of engaging in recurring transactions in the future. In this example, financial devices with a most recent transaction within the last week may be designated as target financial devices, and those without transactions within the last week may or may not be designated as target financial devices. It will be appreciated that other configurations and permutations are possible.

With further reference to the foregoing figures, and by way of further example, a processor may determine all transactions that are associated with a given financial device and determine the type of each transaction, e.g., online transactions, telephonic transactions, written transactions, face-to-face transactions, and/or the like. The processor may determine the number of online transactions that were completed in an observation time period less than or equal to the sample time period, such as a week. The processor may then compare that determined number of online transactions to a threshold number of transactions determined by the predictive model. For example, application of the predictive model on historic financial device data may determine that financial devices that complete at least three online transactions within a given observed week have a statistically higher likelihood of engaging in recurring transactions in the future. In this example, financial devices with at least three online transactions within the observation week may be designated as target financial devices, and those without at least three online transactions within the observation week may or may not be designated as target financial devices. It will be appreciated that other configurations and permutations are possible.

With further reference to the foregoing figures, and by way of further example, a processor may determine all transactions that are associated with a given financial device and determine the type of each transaction, e.g., online transactions, telephonic transactions, written transactions, face-to-face transactions, and/or the like. The processor may determine the number of face-to-face transactions that were completed in an observation time period less than or equal to the sample time period, such as a week. The processor may then compare that determined number of face-to-face transactions to a threshold number of transactions determined by the predictive model. For example, application of the predictive model on historic financial device data may determine that financial devices that complete at least five face-to-face transactions within a given observed week have a statistically higher likelihood of engaging in recurring transactions in the future. In this example, financial devices with at least five face-to-face transactions within the observation week may be designated as target financial devices, and those without at least five face-to-face transactions within the observation week may or may not be designated as target financial devices. It will be appreciated that other configurations and permutations are possible.

With further reference to the foregoing figures, and by way of further example, a processor may determine all transactions that are associated with a given financial device and determine the total amount spent in all transactions. The processor may then compare that determined total transaction amount to a threshold transaction amount determined by the predictive model. For example, application of the predictive model on historic financial device data may determine that financial devices that complete at least $500 worth of transactions in the sample time period have a statistically higher likelihood of engaging in recurring transactions in the future. In this example, financial devices with at least $500 worth of transactions within the sample time period may be designated as target financial devices, and those without at least $500 worth of transactions within the sample time period may or may not be designated as target financial devices. It will be appreciated that other configurations and permutations are possible.

With further reference to the foregoing figures, and by way of further example, a processor may determine all transactions that are associated with a given financial device and determine the category of each merchant associated therewith, e.g., retail, restaurant, utility, recreation, entertainment, and/or the like. The processor may determine the number of transactions that were completed with a specific category of merchants, e.g., retail, in an observation time period less than or equal to the sample time period, such as a week. The processor may then compare that determined number of retail transactions to a threshold number of transactions determined by the predictive model. For example, application of the predictive model on historic financial device data may determine that financial devices that complete at least seven retail transactions within a given observed week have a statistically higher likelihood of engaging in recurring transactions in the future. In this example, financial devices with at least seven retail transactions within the observation week may be designated as target financial devices, and those without at least seven retail transactions within the observation week may or may not be designated as target financial devices. It will be appreciated that other configurations and permutations are possible.

Although the invention has been described in detail for the purpose of illustration based on what is currently considered to be the most practical and preferred and non-limiting embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A computer-implemented method for identifying and communicatively targeting financial devices to promote recurring transactions, the method comprising:
(a) receiving, with at least one processor, financial device data for a plurality of transactions associated with a plurality of financial devices over a sample time period, the financial device data comprising at least one of the following parameters for each financial device of the plurality of financial devices: transaction time, transaction count, transaction amount, merchant category, transaction type, or any combination thereof;
(b) identifying, with at least one processor, at least one target financial device from the financial device data based at least partially on at least one of the parameters having a value in a specified range for the at least one parameter, the value at least partially correlated with a propensity of the at least one target financial device to engage in recurring transactions;
(c) receiving, with at least one processor, identification data of at least one target financial device holder associated with the at least one identified target financial device; and
(d) automatically generating and transmitting at least one communication to the at least one target financial device holder.

2. The computer-implemented method of claim 1, further comprising:
(e) determining, with at least one processor, at least one reactive financial device holder from the at least one target financial device holder that engaged in at least one new recurring transaction during a second sample time period; and
(f) based at least partially on the determination of the at least one reactive financial device holder, modifying a method of communication with the at least one target financial device holder.

3. The computer-implemented method of claim 2, further comprising repeating steps (b) through (f) at predefined intervals.

4. The computer-implemented method of claim 1, wherein the financial device data comprises at least the transaction time parameter, and the identification in step (b) comprises, for each financial device:
determining, with at least one processor, a transaction time of a most recent transaction completed by the financial device;
determining, with at least one processor, a current time;
comparing, with at least one processor, the transaction time of the most recent transaction to the current time; and
based at least partially on the comparison, designating the financial device as a target financial device of the at least one target financial device.

5. The computer-implemented method of claim 1, wherein the financial device data comprises at least the transaction type parameter, and the identification in step (b) comprises, for each financial device:
determining, with at least one processor, a number of transactions completed online in a period of time less than or equal to the sample time period;
comparing, with at least one processor, the number of transactions completed online to a predetermined threshold count; and
based at least partially on the comparison, designating the financial device as a target financial device of the at least one target financial device.

6. The computer-implemented method of claim 1, wherein the financial device data comprises at least the transaction type parameter, and the identification in step (b) comprises, for each financial device:
determining, with at least one processor, a number of face-to-face transactions completed in a period of time less than or equal to the sample time period;
comparing, with at least one processor, the number of face-to-face transactions completed to a predetermined threshold count; and
based at least partially on the comparison, designating the financial device as a target financial device of the at least one target financial device.

7. The computer-implemented method of claim 1, wherein the financial device data comprises at least the transaction amount parameter, and the identification in step (b) comprises, for each financial device:
determining, with at least one processor, a total transaction amount for all transactions completed in a period of time less than or equal to the sample time period;
comparing, with at least one processor, the total transaction amount to a predetermined threshold amount; and
based at least partially on the comparison, designating the financial device as a target financial device of the at least one target financial device.

8. The computer-implemented method of claim 1, wherein the financial device data comprises at least the merchant category parameter, and the identification in step (b) comprises, for each financial device:
determining, with at least one processor, a total number of transactions completed in a period of time less than or equal to the sample time period with merchants being designated in one or more of the following merchant categories: retail, restaurant, utility, recreation, entertainment, or any combination thereof;
comparing, with at least one processor, the total number of transactions to a predetermined threshold count; and
based at least partially on the comparison, designating the financial device as a target financial device of the at least one target financial device.

9. A computer-implemented method for identifying and communicatively targeting financial devices to promote recurring transactions, the method comprising:
(a) receiving, with at least one processor, financial device data for a plurality of transactions associated with a plurality of financial devices over a sample time period, the financial device data comprising at least one of the following parameters for each financial device of the plurality of financial devices: transaction time, transaction count, transaction amount, merchant category, transaction type, or any combination thereof;
(b) identifying, with at least one processor, at least one target financial device from the financial device data based at least partially on at least one of the parameters having a value in a specified range for the at least one parameter, the value at least partially correlated with a propensity of the at least one target financial device to engage in recurring transactions;
(c) determining, with at least one processor, at least one reactive financial device holder associated with the at least one identified target financial device that engaged in new recurring transactions during a second sample time period; and
(d) based at least partially on the determination of at least one reactive financial device holder, implementing at least one of the following steps: adding a new parameter to the at least one parameter, removing a parameter from the at least one parameter, modifying the specified range for the at least one parameter, or any combination thereof.

10. The computer-implemented method of claim 9, further comprising repeating steps (b) through (d) at predefined intervals.

11. The computer-implemented method of claim 9, wherein the financial device data comprises at least the transaction time parameter, and the identification in step (b) comprises, for each financial device:
determining, with at least one processor, a transaction time of a most recent transaction completed by the financial device;
determining, with at least one processor, a current time;
comparing, with at least one processor, the transaction time of the most recent transaction to the current time; and
based at least partially on the comparison, designating the financial device as a target financial device of the at least one target financial device.

12. The computer-implemented method of claim 9, wherein the financial device data comprises at least the transaction type parameter, and the identification in step (b) comprises, for each financial device:
determining, with at least one processor, a number of transactions completed online in a period of time less than or equal to the sample time period;
comparing, with at least one processor, the number of transactions completed online to a predetermined threshold count; and
based at least partially on the comparison, designating the financial device as a target financial device of the at least one target financial device.

13. The computer-implemented method of claim 9, wherein the financial device data comprises at least the transaction type parameter, and the identification in step (b) comprises, for each financial device:
determining, with at least one processor, a number of face-to-face transactions completed in a period of time less than or equal to the sample time period;
comparing, with at least one processor, the number of face-to-face transactions completed to a predetermined threshold count; and
based at least partially on the comparison, designating the financial device as a target financial device of the at least one target financial device.

14. The computer-implemented method of claim 9, wherein the financial device data comprises at least the transaction amount parameter, and the identification in step (b) comprises, for each financial device:
determining, with at least one processor, a total transaction amount for all transactions completed in a period of time less than or equal to the sample time period;
comparing, with at least one processor, the total transaction amount to a predetermined threshold amount; and
based at least partially on the comparison, designating the financial device as a target financial device of the at least one target financial device.

15. The computer-implemented method of claim 9, wherein the financial device data comprises at least the merchant category parameter, and the identification in step (b) comprises, for each financial device:
determining, with at least one processor, a total number of transactions completed in a period of time less than or equal to the sample time period with merchants being designated in one or more of the following merchant categories: retail, restaurant, utility, recreation, entertainment, or any combination thereof;
comparing, with at least one processor, the total number of transactions to a predetermined threshold count; and
based at least partially on the comparison, designating the financial device as a target financial device of the at least one target financial device.

16. A computer-implemented method for identifying and communicatively targeting financial devices to promote recurring transactions, the method comprising:
(a) receiving, with at least one processor, financial device data for a plurality of transactions associated with a plurality of financial devices over a sample time period, the financial device data comprising at least one of the following parameters for each financial device of the plurality of financial devices: transaction time, transaction count, transaction amount, merchant category, transaction type, or any combination thereof;
(b) generating, with at least one processor, a predictive model based at least partially on the financial device data;
(c) determining, at least partially on the predictive model, at least one key parameter correlated with increased incidences of recurring transactions by financial device holders;
(d) identifying, with at least one processor, at least one target financial device from the financial device data based at least partially on the at least one key parameter of the at least one target financial device having a value in a specified range for the at least one key parameter;
(e) receiving, with at least one processor, identification data of at least one target financial device holder associated with the at least one identified target financial device; and
(f) automatically generating and transmitting at least one communication to the at least one target financial device holder.

17. The computer-implemented method of claim 16, wherein the predictive model is generated based on financial device data from a first time range of the sample time period and is validated at least partially on financial device data from a second time range of the sample time period, the validation comprising:
applying, with at least one processor, the generated predictive model to the financial device data from the second time range;
determining, with at least one processor, a confidence score of the predictive model as applied to the financial device data from the second time range; and
modifying, with at least one processor, the predictive model based at least partially on the confidence score.

18.-51. (canceled)
